(19) United States
(12) Patent Application Publication
(10) Pub. No.: US 2026/0083155 A1
(43) Pub. Date: Mar. 26, 2026

(54) TEXTURED PLANT PROTEINS

(71) Applicant: ROQUETTE FRERES, Lestrem (FR)

(72) Inventors: Cyril DROULEZ, Cambrin (FR); Charlotte DLUBAK, Estaires (FR); Audrey DAUSQUE, Houplines (FR)

(21) Appl. No.: 19/109,922

(22) PCT Filed: Sep. 8, 2023
(86) PCT No.: PCT/EP2023/025394

§ 371 Date: Mar. 7, 2025

(30) Foreign Application Priority Data
Sep. 9, 2022 (FR) 2209078

(51) Int. Cl. A23J 3/22; A21D 2/26; A23J 3/18; A23J 3/26

(52) U.S. Cl. CPC A23J 3/227; A21D 2/265; A21D 2/266; A23J 3/18; A23J 3/26

(57) ABSTRACT

The invention relates to a dry-extruded composition comprising plant proteins excluding hydrolyzed wheat gluten, preferably legume proteins, preferably pea proteins, as well as hydrolyzed wheat gluten protein, a method for producing same and the use thereof.

### PRIOR ART

The present invention relates to a specific composition comprising plant proteins excluding hydrolyzed wheat gluten, preferentially from legumes, preferentially from peas, as well as hydrolyzed wheat gluten, said composition having been dry textured. The invention also relates to its manufacturing method and its use in industry, particularly the food industry, even more particularly the meat analog industry.

The technique for texturing proteins, especially by extrusion cooking, with the aim of preparing products with a fibrous structure intended for producing meat and fish analogs, has been applied to numerous plant sources.

The extrusion cooking processes for proteins can be separated into two large families by the amount of water used in the process. When this amount, expressed in percentage of water of the mixture present in the extruder, is greater than a value of the order of 30% by weight, this will usually be referred to as “wet” extrusion cooking, and the products obtained will be more intended for producing finished products for immediate consumption that simulate animal meat, for example, beef steaks or chicken nuggets. For example, patent application WO2014081285 is known, which discloses a method for extruding a mixture of proteins and fibers using a cooling die typical of wet extrusion. However, the present invention is in the field of dry extrusion.

When the amount of water is less than a value of the order of 30% by weight, this is then usually referred to as “dry” extrusion cooking: the products obtained are more intended to be used by food-processing manufacturers, in order to formulate meat substitutes by mixing them with other ingredients. The field of the present invention is that of “dry” extrusion cooking.

Historically, the first proteins used as meat analogs were extracted from soybean and wheat. These two sources rapidly became and remain the main protein sources for this field of application.

For example, patent U.S. Pat. No. 8,741,370 B2 describes a textured plant protein whose protein fraction consists mainly of wheat gluten.

Also known is the article “Textured wheat and pea proteins for meat alternatives applications” (Maningat & al., 2021, DOI: 10.1002/cche.10503). It features various textured plant proteins, derived from pea or wheat gluten.

In these prior art documents in particular, as well as in the vast majority of the literature, the use of unmodified wheat gluten, meaning that it has not been hydrolyzed, is reported.

The use of hydrolyzed wheat gluten is mentioned in the article “Feed technological and nutritional properties of hydrolyzed wheat gluten when used as a main source of protein in extruded diets for rainbow trout (Oncorhynchus mykiss)” (Storebakken & al., 2015, DOI: 10.1016/j.aquaculture.2015.05.029). In this article, hydrolyzed wheat gluten is used to partially replace animal fish protein to produce nutritious pellets via extrusion. The article concludes that “hydrolyzed wheat gluten affected both the extrusion parameters and the physical quality of the granules compared with the fishmeal control. The properties of the hydrolyzed wheat gluten were so strong that significant modifications to the extrusion process were required when the HWG inclusion level reached 269 g/kg.”. This article teaches neither the combined use of hydrolyzed wheat gluten with exclusively plant proteins, nor its use for the production of textured plant proteins. If a person skilled in the art were to grasp this lesson, he would learn that the use of hydrolyzed wheat gluten in extrusion is complicated, impactful and has no effect on the elasticity of the final product (an effect on the firmness of the pellet is reported).

It is to the Applicant's credit that it has gone beyond the above prior art and developed a new specific dry textured composition comprising plant proteins excluding hydrolyzed wheat gluten, preferentially from legumes, preferentially peas, as well as hydrolyzed wheat gluten, enabling said plant proteins to be functionalized, which is not possible with non-hydrolyzed wheat gluten, as will be demonstrated in the examples below.

The terms “textured” and “dry extruded” are interchangeable for the purposes of the present invention.

This invention will be better understood in the following section which aims to disclose a general description thereof.

### GENERAL DESCRIPTION OF THE PRESENT INVENTION

According to a first aspect, the present invention relates to a dry-extruded composition comprising plant proteins excluding hydrolyzed wheat gluten, preferentially leguminous proteins, more preferentially pea proteins, as well as hydrolyzed wheat gluten.

Preferably, the extruded composition according to the invention is characterized by an elasticity measured by Test A of between 3.5 and 5, preferentially between 4 and 5, preferentially between 4.2 and 4.8, preferentially between 4.4 and 4.6

Preferably, the extruded composition according to the invention is also characterized by a firmness measured by Test B of between 5 and 10, preferentially between 5.5 and 9.5

Preferably, the extruded composition according to the invention is also characterized by a water retention capacity measured by Test C of between 1.5 and 3.5, preferentially between 1.7 and 3.2

Preferably, the percentage of hydrolyzed wheat gluten contained in the total proteins is between 22% and 40% on a dry matter basis, preferentially between 22% and 38%, preferentially between 24% and 36%, preferentially between 26% and 34%, preferentially between 28% and 32%.

“Total proteins” is understood to mean all the proteins in the composition according to the first aspect, that is, plant proteins excluding hydrolyzed wheat gluten and hydrolyzed wheat gluten. The percentage “on a dry matter basis” refers to the percentage of hydrolyzed wheat gluten in dry matter with respect to all the proteins in the dry composition according to the first aspect, that is, plant proteins excluding hydrolyzed wheat gluten and hydrolyzed wheat gluten.

Preferably, the percentage of plant proteins excluding hydrolyzed wheat gluten, preferentially leguminous proteins, preferentially pea proteins, contained in the total proteins is between 88% and 60% on a dry matter basis, preferentially between 88% and 62%, preferentially between 76% and 64%, preferentially between 74% and 66%, preferentially between 72% and 68%.

Preferably, hydrolyzed wheat gluten is characterized by a degree of hydrolysis (DH) of 0.5% to 5%, preferably 1% to 4%, preferably 2% to 3%.

Preferably, plant proteins excluding hydrolyzed wheat gluten, preferentially from legumes, are pea or faba bean proteins, or a mixture thereof.

The total protein content within the composition according to the first aspect ranges between 60% and 80% by dry weight with respect to the total weight of dry matter of the composition, preferentially between 70% and 80% by dry weight with respect to the total weight of dry matter of the composition.

Preferably, the composition according to the first aspect has a dry matter content greater than 80% by weight, preferentially greater than 90% by dry weight with respect to the total weight of dry matter of the composition, preferentially between 90% and 100%, preferentially between 95% and 98%.

Preferably, the composition comprises plant fibers, preferentially plant fibers, preferentially leguminous fibers, preferentially pea fibers, in a total protein/plant fiber weight ratio of between 70/30 and 90/10, preferentially between 85/15 and 90/10.

According to a second aspect, the present invention also relates to a method for producing a composition according to the first aspect; said method is remarkable in that it comprises the following steps:
1) Providing a dry powder mixture comprising a material rich in plant proteins excluding hydrolyzed wheat gluten, preferentially leguminous plants, preferentially peas, and a material rich in hydrolyzed wheat gluten in relative quantities enabling a mixture to be obtained in which the percentage of hydrolyzed wheat gluten contained in the total proteins is between 22% and 40% on a dry matter basis, preferentially between 22% and 38%, preferentially between 24% and 36%, preferentially between 26% and 34%, preferentially between 28% and 32%.
3) Dry-extrusion cooking the mixture provided in step 1 with the addition of water to achieve a water content in the extruder of between 1% and 30%
4) Cutting the extruded composition at extruder outlet,
5) Optionally drying the composition thus obtained.

The present invention also relates to a method for producing a protein composition according to the first aspect.

Preferably, plant proteins excluding hydrolyzed wheat gluten, preferentially leguminous proteins, preferentially pea proteins, as well as hydrolyzed wheat gluten are isolates with a protein content on a dry matter basis of between 60% and 90%, preferentially between 70% and 85%, even more preferentially between 75% and 85% by weight relative to the total dry matter of the composition. Protein content refers both to plant protein content excluding hydrolyzed wheat gluten, and to hydrolyzed wheat gluten content, which in turn corresponds to protein.

Preferably, the hydrolyzed wheat gluten protein used in step 1 is characterized by a degree of hydrolysis (DH) of 0.5% to 5%, preferably 1% to 4%, preferably 2% to 3%.

Preferably, plant fibers are added to the powder mixture of step 1. The plant fibers are preferentially selected from the list of legume or potato fibers.

Preferably, the dry weight ratio of total proteins/plant fibers is between 70/30 and 90/10, preferentially between 85/15 and 90/10.

Preferably, the dry weight ratio of total proteins/leguminous fibers is between 70/30 and 90/10, preferentially between 85/15 and 90/10.

Preferably, the plant fiber optionally used contains between 40% and 60% of polymers made up of cellulose, hemicellulose and pectin, preferentially between 45% and 55%, as well as between 25% and 45% of pea starch, preferentially between 30% and 40%, by weight of plant fibers.

Preferably, the leguminous fiber optionally used contains between 40% and 60% of polymers made up of cellulose, hemicellulose and pectin, preferentially between 45% and 55%, as well as between 25% and 45% of pea starch, preferentially between 30% and 40%, by weight relative to the weight of leguminous fibers.

The dry powder mixture comprising total proteins and plant fibers used in step 1 can be prepared by mixing said proteins and fibers. The powder may consist substantially of plant proteins, hydrolyzed wheat gluten and plant fibers.

Preferably, the dry powder mixture comprising the leguminous proteins, hydrolyzed wheat gluten and leguminous fibers used in step 1 can be prepared by mixing said proteins and fibers. The powder can consist substantially of leguminous proteins, hydrolyzed wheat gluten and leguminous fibers.

The term “substantially consist of” means that the powder can comprise impurities associated with the method for producing the plant proteins and the plant fibers, for example, traces of starch. Preferably, the leguminous protein and fiber are selected from faba bean and pea. Pea is particularly preferred.

Preferably, the plant protein and fiber are selected from leguminous proteins and fibers, preferably from faba beans and peas. Pea is particularly preferred.

According to one embodiment, the proteins and fibers have the same botanical origin.

According to another embodiment, the proteins and fibers have different botanical origins.

Finally, the present invention relates to the use of the composition according to the first aspect or produced according to the method according to the second aspect in industrial applications such as, for example, the human and animal food industry, industrial pharmaceuticals or cosmetics.

Finally, the present invention relates to the use of the composition according to the first aspect or produced according to the method according to the second aspect in a food composition, preferably intended for preparing a bakery or pastry product and/or preferably being a meat analogue, such as minced meat, steaks, chicken fillets, chicken nuggets, sausages, in a pharmaceutical composition or in a cosmetic composition.

The present invention will be better understood upon reading the following detailed description.

### BRIEF DESCRIPTION OF THE DRAWINGS

Other features, details and advantages will appear from reading the following detailed description, and by analyzing the appended drawings in which:

FIG. 1

FIG. 1 is a photo showing the behavior of a composition according to the invention when subjected to shear in three bottles.

FIG. 2

FIG. 2 is a photo showing the behavior of a prior art composition (100% pea protein) when subjected to shear in three bottles.

FIG. 3

FIG. 3 is a photo showing the behavior of a prior art composition (70% pea protein and 30% non-hydrolyzed wheat gluten) when subjected to shear in three bottles.

### DETAILED DESCRIPTION OF THE PRESENT INVENTION

The present invention relates to a dry-extruded composition comprising plant proteins excluding hydrolyzed wheat gluten, preferentially leguminous proteins, preferentially pea proteins, as well as hydrolyzed wheat gluten.

The term “plant proteins” is to be understood as any extract containing proteins from plant sources. For the purposes of the present invention, the term “plant proteins” should be read as “plant proteins excluding hydrolyzed wheat gluten”. For the sake of clarification, proteins derived from eggs, milk or animals are excluded from this designation, while proteins derived from plants or algae are included. Moreover, because the proteins extracted in this way are of plant origin, they de facto include other constituents, otherwise known as impurities, from the same plant source.

The term “leguminous” is considered herein to mean the family of dicotyledonous plants of the order Fabales. This is one of the largest flowering plant families, third after Orchidaceae and Asteraceae in terms of number of species. It contains approximately 765 genera, bringing together more than 19,500 species. Several leguminous plants are important crop plants, including soybean, beans, peas, faba beans, chickpeas, peanuts, cultivated lentils, cultivated alfalfa, various clovers, broad beans, carob and licorice.

Preferably, plant proteins excluding hydrolyzed wheat gluten, preferentially from legumes, are pea or faba bean proteins, or a mixture thereof.

The term “pea” is considered here in its broadest accepted use and includes in particular all the varieties of “smooth pea” and “wrinkled pea” and all the mutant varieties of “smooth pea” and “wrinkled pea”, regardless of the uses for which said varieties are usually intended (human food, animal feed and/or other uses).

The term “pea” in the present application includes pea varieties belonging to the Pisum genus and more particularly to the species sativum and aestivum. Said mutant varieties are in particular those named “r mutants”, “rb mutants”, “rug 3 mutants”, “rug 4 mutants”, “rug 5 mutants” and “lam mutants” as described in the article by C-L HEYDLEY et al., entitled “Developing novel pea starches” Proceedings of the Symposium of the Industrial Biochemistry and Biotechnology Group of the Biochemical Society, 1996, pages 77-87.

“Faba bean” is intended to mean the group of annual plants of the species Vicia faba, belonging to the group of leguminous plants of the Fabaceae family, Faboideae subfamily, Fabeae tribe. A distinction is made between Minor and Major varieties. In the present invention, wild-type varieties and those obtained by genetic engineering or varietal selection are all excellent sources.

If the leguminous proteins, in particular derived from peas or faba beans, are particularly adapted to the use of the invention, it is nevertheless possible to achieve the latter with other sources of plant proteins such as oat, mung bean, potato, corn or even chickpea protein. The person skilled in the art will know how to make any necessary adjustments.

“Textured” or “texturing” in the present application is understood to mean any physical and/or chemical process that aims to modify a composition comprising proteins in order to give them a specific ordered structure. Within the scope of the invention, texturing proteins aims to give the appearance of a fiber, such as those present in animal meats. As will be described throughout the remainder of this description, a particularly preferred method for texturing proteins is extrusion cooking, particularly using a twin-screw extruder.

“Dry-textured” or “dry-texturing” as used in this application refers to a texturing method, in particular by cooking-extrusion, wherein the amount of water in the mixture present in the extruder represents less than 30% of the total weight of the ingredients used in the method, preferentially between 1% and 30%. Typically, as detailed below, the composition of the present application is preferably prepared by cooking-extrusion by introducing a powder and water into an extruder, said powder containing proteins and optionally leguminous fibers, and in this context the expression “dry textured” means that the weight of water introduced into the extruder represents less than 30% of the total weight of the ingredients used in the method, preferentially between 1% and 30% of the total weight of water and powder introduced into the extruder, more preferably between 5 and 25%.

Any drinking water is suitable for this purpose.

“Drinking water” is understood to mean water that can be drunk or used for domestic and industrial purposes without posing health risks. Preferentially, its conductivity is selected between 400 and 1,100, preferentially between 400 and 600 μS/cm. More preferably in the present invention, it will be understood that this drinking water has a sulfate content of less than 250 mg/l, a chloride content of less than 200 mg/l, a potassium content of less than 12 mg/l, a pH ranging between 6.5 and 9 and a total hardness (TH, namely the hardness of the water, corresponding to the measurement of the calcium and magnesium ions content in water) of more than 15 French degrees. In other words, drinking water must not have less than 60 mg/l of calcium or 36 mg/l of magnesium. This definition includes water from the drinking water network, decarbonated water, demineralized water.

Preferably, the extruded composition according to the invention is characterized by an elasticity measured by Test A of between 3.5 and 5, preferentially between 4 and 5, preferentially between 4.2 and 4.8, preferentially between 4.4 and 4.6

### Test A

The elasticity of the extruded composition is measured using test A described below:
100 g+/−1 g of textured composition is screened using a 0.8 cm mesh sieve
The reject from this screening is hydrated in water at room temperature (+/−15° C.) and in an excess amount of water. After 5 minutes of hydration, remove the water using a 1 mm mesh sieve;
Measurement is performed using TA Instrument Texturometer TAXT, equipped with an Ottawa cell;
To limit water splashing during measurement, a piece of synthetic sponge (e.g. Spontex® or Raja@) is cut to fit the shape of the Ottawa cell, then placed at the bottom of the measurement cell.
Place a layer of hydrated extruded composition on the bottom of the Ottawa cell, on top of the sponge. Ensure a homogeneous surface to limit measurement inaccuracies (single-layer, uniform thickness, even distribution).

Using the TAXT software, define a stress using the following parameters: a force of 5 N, a strain level of 50% and a speed of 5 mm/s.—After the TAXT device has applied compression, it is stopped and the compressed textured protein composition is allowed to exert back pressure on the Ottawa cell probe. The distance traveled by the probe of the Ottawa cell necessary until no force is measured is recorded. This distance represents the elasticity of the product according to Test A.

Preferably, the elasticity according to Test A of the composition according to the invention measured by Test A will be 3.5; 3.6; 3.7; 3.8; 3.94; 4.1; 4.2; 4.3; 4.4; 4.5; 4.6; 4.7; 4.8; 4.9 or 5, as well as all the ranges obtainable with these values.

Preferably, the extruded composition according to the invention is also characterized by a firmness measured by Test B of between 5 and 10, preferentially between 5.5 and 9.5.

### Test B

In order to measure the firmness of the composition according to the invention, test B is used, the protocol of which is described below:
a. Weigh 20 g of sample to be analyzed into a beaker
b. Add demineralized water at ambient temperature (temperature between 10° C. and 20° C., preferentially 20° C.+/−1° C.)
c. Leave in static contact for 5 minutes by placing a 250 g weight on the sample to ensure that it is immersed;
d. Separate residual water and the rehydrated sample using a sieve making it possible to separate the sample and the residual water;
e. Deposit the rehydrated sample at the bottom of an Ottawa cell (cell in the form of a standard plexiglas block, with a volume of 440 ml), equipping a TA.HD plusC Texture Analyzer texturometer connected to the Exponent Connect Version 7.0.4.0 software, and equipped with a 50 kg force sensor (“load cell”)
f. Start the analysis with the following parameters: pre-test speed=1 mm/s, test speed=5 mm/s, post-test speed=10 mm/s, strain=50%, trigger force=750 kg;

The firmness value corresponds to the maximum force (expressed in kg) obtained during the analysis (3 repetitions are carried out and the arithmetic mean is calculated)

Preferably, the firmness according to Test B of a composition according to the invention will be 5; 5.1; 5.2; 5.3; 5.4; 5.5; 5.6; 5.7; 5.8; 5.9; 6; 6.1; 6.2; 6.3; 6.4; 6.5; 6.6; 6.7; 6.8; 6.9; 7; 7.1; 7.2; 7.3; 7.4; 7.5; 7.6; 7.7; 7.8; 7.9; 8; 8.1; 8.2; 8.3; 8.4; 8.5; 8.6; 8.7; 8.8; 8.9; 9; 9.1; 9.2; 9.3; 9.4; 9.5; 9.6; 9.7; 9.8; 9.9 or 10, as well as all ranges obtainable with these values.

Preferably in the absence of plant fibers in the composition, the Test B firmness of the composition according to the invention will be between 5 and 7, preferentially between 5.5 and 6.5.

Alternatively in the presence of plant fibers in the composition, the Test B firmness of the composition according to the invention will be between 8 and 10, preferentially between 8.5 and 9.5.

Preferably, the extruded composition according to the invention is also characterized by a water retention capacity measured by Test C of between 1.5 and 3.5, preferentially between 1.7 and 3.2.

### Test C

In order to measure the water holding capacity, test C is used, the protocol of which is described below:
a. Weigh 40 g of sample to be analyzed into a beaker
b. Add demineralized water at ambient temperature (20° C.+/−1° C.) until the sample is completely submerged;
c. Leave in static contact for 30 minutes;
d. Separate residual water and the sample using a sieve making it possible to separate the sample and the residual water;
d. Weigh the final weight P (in grams) of the rehydrated sample;

The computation for water holding capacity, expressed as grams of water per gram of protein analyzed, is as follows:

$$Water holding capacity = ( P - 40 ) / 40.$$

Preferably, the water retention capacity according to Test C of a composition according to the invention will be 1.5; 1.6; 1.7; 1.8; 1.9; 2; 2.1; 2.2; 2.3; 2.4; 2.5; 2.6; 2.7; 2.8; 2.9; 3; 3.1; 3.2; 3.3; 3.4; or 3.5, as well as all the ranges obtainable with these values.

Preferably in the absence of plant fibers in the composition, the Test C water retention of the composition according to the invention will be between 2.5 and 3.5, preferentially between 2.7 and 3.0.

Alternatively in the presence of plant fibers in the composition, the Test C water retention of the composition according to the invention will be between 1.5 and 2.5, preferentially between 1.7 and 2.3

Preferably, the percentage of hydrolyzed wheat gluten contained in the total proteins of the composition is between 22% and 40% on a dry matter basis, preferentially between 22% and 38%, preferentially between 24% and 36%, preferentially between 26% and 34%, preferentially between 28% and 32%. Even more preferably, the percentage of plant proteins excluding hydrolyzed wheat gluten, preferentially leguminous proteins, preferentially pea proteins, contained in the total proteins is between 88% and 60% on a dry matter basis, preferentially between 88% and 62%, preferentially between 76% and 64%, preferentially between 74% and 66%, preferentially between 72% and 68%.

In this application, “hydrolyzed wheat gluten” is to be understood as vital wheat gluten (see its definition below), which has been hydrolyzed, which is to be understood as a reduction in the molecular weight of the proteins making up wheat gluten. In order to hydrolyze wheat gluten, the person skilled in the arts can choose between all the processes known today, including chemical routes, e.g. acid or alkaline hydrolysis, or biochemical routes, e.g. proteases, peptidases.

In this application, “wheat gluten” is understood to mean the wheat protein fraction consisting of gliadins and glutenins. Preferably, the gluten will be “vital”, which means that it will be obtained by a method that does not denature it and thus retains its viscoelastic properties.

In a preferred embodiment, hydrolyzed wheat gluten is characterized by a degree of hydrolysis (DH) of 0.5% to 5%, preferably 1% to 4%, preferably 2% to 3%. The degree of hydrolysis is defined as the proportion of cleaved peptide bonds in a protein hydrolysate. The degree of hydrolysis can be easily determined using well-known protocols such as o-phthaldialdehyde (OPA) or trinitrobenzenesulfonic acid (TNBS) colorimetric methods. In this application, the preferred method is OPA. The person skilled in the art may refer to the article “Improved Method for Determining Food ProteinDegree of Hydrolysis” (Journal of Food Science, Volume 66, Issue 5, June 2001, Pages 642-646).

The measurement protocol for determining the degree of hydrolysis (DH) is described below.

The content of amino nitrogen (free NH₂) is determined first of all on the sample of proteins according to the invention with the MEGAZYME kit (reference K-PANOPA). The content of protein nitrogen (total nitrogen) of the sample is also determined. It is then possible to calculate the degree of hydrolysis.

### Determining the Content of Amino Nitrogen:

The “amino nitrogen” groups of the free amino acids in the sample react with the N-acetyl-L-cysteine and ophthaldialdehyde (OPA) to form isoindole derivatives.

The amount of isoindole formed during this reaction is stoichiometric with the amount of free amino nitrogen. It is the isoindole derivative which is measured by the increase in absorbance at 340 nm.

A test specimen P*, exactly weighed, of the sample to be analyzed is introduced into a 100 ml beaker. This test specimen will be from 0.5 to 5.0 g based on the amino nitrogen content of the sample. Approximately 50 ml of distilled water is added, homogenization is carried out and the mixture is decanted into a 100-ml graduated flask. 5 ml of 20% sodium dodecyl sulfate (SDS) are added, and the mixture is supplemented with distilled water to reach a volume of 100 ml. Stirring is carried out for 15 minutes with a magnetic stirrer at 1000 rpm. A solution no. 1 is prepared by dissolving a tablet from bottle 1 of the Megazyme kit in 3 ml of distilled water and stirring is carried out until it is completely dissolved. It is necessary to provide one tablet per test. Solution no. 1 is prepared immediately before use.

A blank, a standard and a sample are directly prepared in the cuvettes of the spectrophotometer under the following conditions:
blank: introduce 3.00 ml of solution No. 1 and 50 μl of distilled water
standard: introduce 3.00 ml of solution No. 1 and 50 μl of bottle 3 of the Megazyme kit
sample: introduce 3.00 ml of solution No. 1 and 50 μl of the sample preparation.

The content of each cuvette is mixed and the measure of absorbance (A1) of the solutions is taken after approximately 2 mn in the spectrophotometer at 340 nm (spectrophotometer equipped with cuvettes with 1.0 cm of optical path, able to measure at a wavelength of 340 nm, and verified according to the procedure described in the related manufacturer's technical manual).

The reactions are then immediately initiated by adding 100 μl of solution no. 2, which corresponds to the OPA solution of bottle 2 of the Megazyme kit in each spectrophotometer cuvette.

The content of each cuvette is mixed and they are then placed in darkness for approximately 20 minutes.

The measure of absorbance A2 of the blank, the standard and the sample are then taken from the spectrophotometer at 340 nm.

The free amino nitrogen content, expressed as percentage by weight relative to the weight of the product, is given by the following formula:

$$\% amino nitrogen = \frac{( Δ Aech - Δ Ablc ) \times 3.15 \times 14.01 \times V \times 100}{6803 \times 0.05 \times m \times 1000}$$

$$\% amino nitrogen = \frac{( Δ Aech - Δ Ablc ) \times 12.974 \times V}{m \times 1000}$$

where:
ΔAech=Aech2−Aech1
ΔAblc=Ablc2−Ablc1
Aech2=absorbance of the sample after adding solution no. 2
Aech1=absorbance of the sample after adding solution no. 1
Ablc2=absorbance of the blank after adding solution no. 2
Ablc1=absorbance of the blank after adding solution no. 1
V=volume of the flask
m=weight of the test specimen in g
6803=extinction coefficient of the isoindole derivative at 340 nm (in l·mol⁻¹·cm⁻¹).
14.01=molar mass of the nitrogen (in g·mol⁻¹)
3.15=final volume in the cuvette (in ml)
0.05=test specimen in the cuvette (in ml)

### Determining the Content of Protein Nitrogen:

The content of protein nitrogen is determined according to the DUMAS method according to standard ISO 16634-2016. It is expressed as percentage by weight relative to the weight of the product.

### Calculation of the Degree of Hydrolysis

The degree of hydrolysis (DH) is calculated with the following formula:

$$D H = \frac{\% amino nitrogen}{\% protein nitrogen} \times 100$$

In a preferred manner, the composition according to the invention has a dry matter content greater than 80%, preferentially greater than 90% by weight of solids with respect to the total weight of the composition.

The dry matter is measured using any method that is well known to a person skilled in the art. Preferably, the “desiccation” method is used. It involves determining the amount of water evaporated by heating a known amount of a sample of known mass. Heating is continued until the mass stabilizes, indicating that the water has evaporated completely. Preferably, the temperature used is 105° C.

The total protein content of the composition according to the invention advantageously ranges between 60% and 80%, preferentially between 70% and 80% by weight relative to the total dry matter of the composition. Any method well known to the person skilled in the art can be used to analyze this protein content. Preferably, the total nitrogen amount, typically according to the Kjeldahl method, will be assayed and this content will be multiplied by the coefficient 6.25. This method is well known to the person skilled in the art and is commonly used to analyze the protein content of plant protein compositions.

The composition according to the present application may also comprise plant fibers.

Preferably, the composition comprises plant fibers selected from the list of leguminous fibers, such as pea fibers, in a total protein/plant fiber weight ratio of between 70/30 and 90/10, preferentially between 85/15 and 90/10. Preferably, the composition comprises dry-textured leguminous proteins and fibers in particulate form, in a total protein/leguminous fiber weight ratio of between 70/30 and 90/10, preferentially between 85/15 and 90/10. When the composition of the present application comprises leguminous fibers, the proteins and fibers come from the same legume or from different legumes, preferably from the same legume. In a particular embodiment, the composition of the present application comprises pea or faba bean proteins and fibers.

In a preferred embodiment, the composition may also comprise potato fibers.

In addition to all the aforementioned compounds, the composition according to the invention can of course comprise other compounds such as colorants, flavors, amino acids or peptides (to improve nutritional quality), additives such as calcium carbonate or sodium metabisulfite.

The present invention also relates to a method for producing a composition according to the first aspect; said method is remarkable in that it comprises the following steps:
1) Providing a dry powder mixture comprising a material rich in plant proteins, preferentially leguminous plants, preferentially peas, and a material rich in hydrolyzed wheat gluten protein in relative quantities enabling a mixture to be obtained in which the percentage of hydrolyzed wheat gluten contained in the total proteins is between 22% and 40% on a dry matter basis, preferentially between 22% and 38%, preferentially between 24% and 36%, preferentially between 26% and 34%, preferentially between 28% and 32%.
2) Dry-extrusion cooking the mixture provided in step 1 with the addition of water to achieve a water content in the extruder of between 1% and 30%
3) Cutting the extruded composition at extruder outlet
4) Optionally drying the composition thus obtained.

The dry powder mixture comprising plant proteins excluding hydrolyzed wheat gluten, preferentially leguminous plants, preferably peas, as well as hydrolyzed wheat gluten used in step 1 can be prepared by mixing said materials prior to introduction into the extruder. The powders can also be weighed separately and then fed together to the extruder feeder. The powder can consist substantially or even exclusively of leguminous proteins and hydrolyzed gluten. Mixing consists in obtaining a dry mixture of the various constituents required to give the composition a fibrous appearance in step 2, once this has been mixed with water and extruded.

Preferably, the hydrolyzed wheat gluten used in step 1 has a degree of hydrolysis (DH) of 0.5% to 5%, preferably 1% to 4%, preferably 2% to 3%.

Preferably, materials rich in plant proteins excluding hydrolyzed wheat gluten, preferentially from leguminous plants, preferentially peas, as well as materials rich in hydrolyzed wheat gluten are isolates with a total protein content on a dry matter basis of between 60% and 90%, preferentially between 70% and 85%, preferentially between 75% and 85% by weight on the total dry matter of the composition.

Any method well known to the person skilled in the art can be used to analyze this total protein content. Preferably, the total amount of nitrogen is determined using the Kjeldahl method, then multiplied by the coefficient 6.25 to obtain the amount of protein. Preferably, the dry matter of the plant protein, preferentially leguminous plants, is greater than 80% by weight, preferentially greater than 90% by dry weight, with respect to the total weight of dry matter of the composition.

Even more preferably, the plant proteins excluding hydrolyzed wheat gluten, preferentially leguminous proteins, preferentially pea proteins, have a particle size characterized by a Dmode ranging between 150 microns and 400 microns, preferentially between 150 microns and 200 microns or between 350 microns and 450 microns. The measurement of this particle size is carried out using a MALVERN 3000 laser particle size analyzer in the dry phase (equipped with a powder module). The powder to be analyzed is placed in the feeder for the module with an opening ranging between 1 and 4 mm and a vibration frequency of 50% or 75%. The device automatically records the various sizes and adjusts the Particle Size Distribution (or PSD) as well as the Dmode, D10, D50 and D90. The Dmode is well known to a person skilled in the art and consists of the size of the largest population of particles.

The particle size of the powder is advantageous for the stability and the productivity of the method. An excessively fine particle size is irrevocably followed by problems that are sometimes difficult to manage during the extrusion method.

Preferably, the dry powder mixture of step 1 may also contain plant fibers, preferentially leguminous plants, characterized in that the powder mixture thus obtained has a dry weight ratio of total proteins/plant fibers, preferentially leguminous plants, ranging between 70/30 and 90/10, preferentially ranging between 85/15 and 90/10.

“Plant fiber” is understood to mean any compositions comprising polysaccharides that are relatively indigestible or indigestible by the human digestive system, extracted from plant sources. “Leguminous fiber” is understood to mean any compositions comprising polysaccharides that are relatively indigestible or indigestible by the human digestive system, extracted from leguminous plants. Such fibers are extracted using any method that is well known to the person skilled in the art. Preferably, the leguminous fibers are pea, faba bean, mung bean or chickpea fibers, or a mixture thereof. When leguminous fibers are used in the method according to the present application, the proteins and fibers come from the same legume or from legumes of different botanical origins, preferably from the same legume. In a particular embodiment, the method is used with pea or faba bean proteins and fibers.

In the case of plant fibers, these are preferentially extracted from plants, preferentially peas, using a wet extraction method. The dehulled pea is reduced to flour, which is then suspended in water. The suspension thus obtained is sent to hydrocyclones in order to extract the starch. The supernatant is sent to horizontal settling tanks in order to obtain a leguminous fiber fraction. Such a method is described in patent application EP2950662. A leguminous fiber thus prepared contains between 40% and 60% of polymers made up of cellulose, hemicellulose and pectin, preferentially between 45% and 55%, as well as between 25% and 45% of pea starch, preferably between 30% and 40%. A commercial example of such a fiber is, for example, the Pea Fiber 150 fiber by Roquette.

The mixing of proteins and fibers (fiber/protein mixing) can be carried out upstream using a dry mixer, or directly when the extruder is fed. During this mixing, additives can be added that are well known to the person skilled in the art, such as flavorings or even dyes.

In an alternative embodiment, the fiber/protein mixture is naturally obtained by turboseparation of a leguminous flour. The leguminous plant seeds are cleaned, their outer fibers are removed, and they are ground to flour. The flour is then turboseparated, which consists in applying a rising stream of air, enabling the different particles to be separated based on their density. It is possible to concentrate the content of proteins in the flours from approximately 20% to more than 60%. Such flours are called “concentrates”. These concentrates also contain between 10% and 20% of leguminous fibers.

The dry weight ratio between total proteins and fibers is advantageously between 70/30 and 90/10, preferentially between 85/15 and 90/10.

Alternatively, leguminous fiber can be replaced by any suitable plant fiber, including potato fiber or lemon fiber.

During step 2, this dry powder mixture will then be textured, which is the same as saying that the plant proteins and hydrolyzed wheat gluten will undergo thermal destructuring and reorganization in order to form a continuous elongation in straight, parallel lines, simulating the fibers present in meats. Any method well known to the person skilled in the art will be suitable, in particular extrusion.

Extrusion consists in forcing a product to flow through a small hole, the die, under the action of high pressures and shearing forces, using the rotation of one or two Archimedes screws. The resulting heating causes cooking and/or denaturing of the product, hence the term sometimes used, “extrusion cooking”, then expansion by evaporation of the water at the die outlet. This technique makes it possible to develop products which are widely varied in their composition, their structure (expanded and alveolar form of the product), and their functional and nutritional properties (denaturing of anti-nutritional or toxic factors, sterilization of food, for example). Processing of proteins often leads to structural modifications which are reflected by obtaining products with a fibrous appearance, simulating animal meat fibers. In the present application, the cooking-extrusion step is preferably carried out by the dry method, that is, the amount of water introduced into the extruder represents less than 30% of the total weight of water and powder introduced into the extruder. In the present application, this percentage can be obtained by dividing the amount of water introduced into the extruder by the total of the amount of powder and water introduced into the extruder, and multiplying by 100. Preferably, the amount of water in the mixture in the extruder is between 1% and 30%, preferably 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29% or 30%.

Any drinking water is suitable for this purpose. “Drinking water” is understood to mean water that can be drunk or used for domestic and industrial purposes without posing health risks. Preferentially, its conductivity is selected between 400 and 1,100, preferentially between 400 and 600 μS/cm. More preferably in the present invention, it will be understood that this drinking water has a sulfate content of less than 250 mg/l, a chloride content of less than 200 mg/l, a potassium content of less than 12 mg/l, a pH ranging between 6.5 and 9 and a total hardness (TH, namely the hardness of the water, corresponding to the measurement of the calcium and magnesium ions content in water) of more than 15 French degrees. In other words, drinking water must not have less than 60 mg/l of calcium or 36 mg/l of magnesium. This definition includes water from the drinking water network, decarbonated water, demineralized water.

Preferably, step 2 is carried out by extrusion cooking in a twin-screw extruder characterized by a length to diameter ratio ranging between 20 and 60, preferentially between 20 and 45, preferentially between 35 and 45, preferentially 40, and equipped with a series of 85-95% feeding elements, 2.5-10% kneading elements, and 2.5-10% reverse pitch elements.

The length to diameter ratio is a conventional parameter in extrusion cooking. This ratio therefore can be 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64 or 65. Preferably, the length/diameter ratio will be between 55 and 65, preferentially between 58 and 62, even more preferentially 60.

The various elements are the feeding elements intended for feeding the product into the die without modifying the product, the kneading elements intended for mixing the product and the reverse pitch elements intended for applying a force to the product to cause it to advance in the opposite direction and thus cause mixing and shearing.

Preferably, the conveying elements will be placed at the very beginning of the screw with a temperature set between 20° C. and 70° C., then the kneading elements with a temperature between 90° C. and 150° C. and finally the reverse pitch elements with temperatures between 100° C. and 140° C., preferentially between 100° C. and 120° C. Alternatively, the conveying elements will be placed at the very beginning of the screw with a temperature set between 20° C. and 70° C., followed by an alternation of shearing and reverse pitch elements with temperatures between 9° and 140° C., respectively.

Preferably, this screw is rotated between 900 and 1200 revolutions/min, preferentially between 900 and 1100 revolutions/min.

Step 3 then consists in cutting the extruded composition at the extruder outlet, consisting at least of a die.

In a first variant, cutting can be carried out naturally, that is, by simply ejecting the extruded composition and breaking the rod due to the force of ejection and gravity.

In a second variant, the die is equipped with orifices, with a diameter of

3 mm, and a knife whose rotation speed is between 600 and 1000 rpm, preferentially between 700 and 900 rpm, even more preferentially 800 rpm.

Preferably, the distance between the knife and the end of the die is adjusted to obtain an extruded composition with an average length of between 0.5 cm and 1.5 cm, preferentially between 0.7 cm and 1.3 cm, preferentially between 0.9 cm and 1.2 cm.

The knife is placed flush with the outlet of the extruder, preferably at a distance ranging between 0 and 5 mm. “Flush” is understood to be at a distance extremely close to the die located at the outlet of the extruder, at the limit of touching the die but without touching it. Conventionally, the person skilled in the art will adjust this distance by making the knife and the die touch each other, then by shifting the latter very slightly.

The last step 4 involves drying the composition thus obtained. This step is optional but preferred.

A person skilled in the art will know how to use the appropriate technology in order to dry the composition according to the invention from the wide selection currently available to them. Without limitation and solely by way of an example, air flow dryers, microwave dryers, fluidized bed dryers or vacuum dryers can be cited. A person skilled in the art will select the correct parameters, mainly the time and temperature, in order to achieve the desired final dry matter.

Preferably, drying is carried out to achieve a dry matter content of between 90% and 100%, preferentially between 95% and 98%.

Finally, the present invention relates to the use of the composition according to the first aspect in industrial applications such as, for example, the human and animal food industry, industrial pharmaceuticals or cosmetics.

Another object of the present invention is a food composition comprising an extruded composition according to the first aspect.

Another object of the present invention is a pharmaceutical composition comprising an extruded composition according to the first aspect.

Another object of the present invention is a cosmetic composition comprising an extruded composition according to the first aspect.

The human and animal food industry is understood to mean industrial confectionery (for example, chocolate, caramel, jelly sweets), bakery products (for example, bread, brioches, muffins), the meat and fish industry (for example, sausages, minced steaks, fish nuggets, chicken nuggets), sauces (for example, bolognese, mayonnaise), products derived from milk (for example, cheese, plant milk), beverages (for example, high protein beverages, powdered beverages to be reconstituted).

More preferably, the present invention relates to the use of the composition according to the first aspect in the field of baking.

The invention will be of particular interest in order to produce inclusions in bakery products such as muffins, cookies, cakes, bagels, pizza dough, breads and breakfast cereals.

The term “inclusions” is understood to mean particles (in this case the composition of leguminous proteins textured in a dry process) mixed with a dough before it is cooked. After this step, the composition of leguminous proteins textured in a dry process is trapped in the final product (hence the term “inclusion”) and provides both its protein content as well as crunchiness when consumed.

The invention will be of particular interest in order to produce inclusions in confectionery products such as fat filings, chocolates, so as to also provide protein retention as well as crunchiness.

The invention will be of particular interest in order to produce inclusions in products that are alternatives to dairy products such as cheeses, yogurts, ice creams and beverages.

The invention will be of particular interest in the field of analogs of meat, fish, sauces, soups.

A particular application relates to the use of the composition according to the invention for manufacturing meat substitutes, in particular minced meat. Other options are bolognese sauce, hamburger patties, meat for tacos and pitas, and “chili sin carne”.

In pizzas, the composition comprising textured leguminous proteins according to the invention will be of particular interest for being sprinkled on top of said pizza (“topping”).

In dehydrated ready meals (for example, Bolino in Europe or Good Dot in India), the textured composition according to the invention will be used as an element providing fiber and protein. Thus, a product can be obtained that hydrates quickly and to its core, while being pleasing to chew.

The invention will be better understood upon reading the following non-limiting examples.

### EXAMPLES

The following examples will be used:
The NUTRALYS® F85G (from ROQUETTE) as pea protein isolate
   Richness in protein=84.1%
   Dry matter=94.3%
The NUTRALYS® W (from ROQUETTE) as hydrolyzed wheat gluten protein protein isolate
   Richness in protein=84%
   Dry matter=92%
   Degree of hydrolysis (OPA method)=2.7%
VITEN® (from ROQUETTE) as vital wheat gluten protein.
   Richness in protein=77%
   Dry matter=92%

### Description of the Common Part of the Method for Producing a Composition of Leguminous Proteins Textured in a Dry Process Used for all the Examples

This description is general to all of the tests/examples. The particularities (composition, flow rates, settings, will be specified in Table 1 below)

The dry powder mixture is introduced by gravity into a LEISTRITZ ZSE 27MAXX twin-screw extruder (L/D=60, with 15 sheaths).

The mixture is introduced with a flow rate regulated in kg/h. A regulated amount of water in kg/h is also introduced. A water to powder mass ratio is therefore calculated and expressed in %.

The extrusion screw, made up of 85% feeding elements, 5% kneading elements and 10% reverse pitch elements, is rotated at a speed regulated in rpm and sends the mixture to a die. As indicated in the description, the feeding elements have been placed at the very beginning of the screw with a temperature set between 20° C. and 70° C., then the kneading elements and the reverse pitch elements with temperatures ranging between 90° C. and 150° C.

This particular procedure generates a machine torque expressed in % with an outlet pressure read in bars. The specific energy of the system is calculable (according to the conventional knowledge of the person skilled in the art) and expressed in Wh/kg.

The product is directed at the outlet toward a die made up of a 3 mm cylindrical hole, from which the textured protein is expelled, which is cut using knives placed flush with the outlet of the extrusion die.

The textured/extruded composition thus produced is dried in a Thermo Scientific model UT6760 ventilated oven heated to 60° C.

The elasticity of the extruded composition is measured using test A described in paragraphs 60 to 62 of this application.

Fibration (formation of protein fibers similar to animal meat muscle fibers) is also assessed visually (protocol: hydration for 30 min in drinking water at room temperature, screening to remove water and manual dilaceration of the sample, observing the formation or absence of fibers similar to those observed on cooked chicken, for example): +++excellent fibration/++good fibration/+homogeneous fibration/−non-homogeneous fibration/−−poor fibration/−−−no fibration Finally, the density is assessed using the protocol described below:
a. taring a 2 liter graduated test tube;
b. Fill the cylinder with the product to be analyzed. Preferably, it can be ensured that the product fills the 2-liter volume by means of small impacts on the wall of the test tube;
c. Weigh the test tube filled with the product. A weight P in grams is obtained;
d. Density calculation: Density=(P/2)

### Example 1: Impact of the Percentage and Degree of Hydrolysis of Hydrolyzed Wheat Gluten Isolate

Table 1 below summarizes the various tests carried out as well as the analyses corresponding to the compositions obtained.

| | | | | | Ex. 3 | Ex. 3 | | | Ex. 5 |
|---|---|---|---|---|---|---|---|---|---|
| | | Ex. 1 | Ex. 2 | Ex. 3 | bis | ter | Ex. 4 | Ex. 5 | bis |
| Composition | Internal pea fibers | 0 | 0 | 0 | 0 | 0 | 0 | 0 | 0 |
| (quantities expressed | (PEA FIBER I50M) | | | | | | | | |
| as percentage by | Soluble pea protein isolate | 100 | 70 | 80 | 75 | 65 | 55 | 70 | 70 |
| weight of the total | (NUTRALYS F85G) | | | | | | | | |
| mass of the powder | Wheat gluten protein | 0 | 0 | 0 | 0 | 0 | 0 | 30 | 30 |
| mixture feeding the | isolate (VITEN) | | | | | | | | |
| extruder) | Hydrolyzed wheat gluten | 0 | 30 | 20 | 25 | 35 | 45 | 0 | 0 |
| | protein isolate | | | | | | | | |
| | (NUTRALYS W) | | | | | | | | |
| Extrusion settings | Powder flow rate (kg/h) | 35 | 35 | 35 | 35 | 35 | 35 | 35 | 35 |
| | Water flow rate (kg/h) | 10.5 | 8 | 8 | 7.8 | 15.0 | 5.6 | 8.8 | 8.4 |
| | % water | 23% | 19% | 19% | 18% | 13% | 18% | 20% | 19% |
| | Screw Speed (in rpm) | 1150 | 1150 | 1150 | 1150 | 1150 | 1150 | 900 | 1150 |
| | Torque (%) | 25 | 28 | 27 | 25 | 30 | 26 | 32 | 30 |
| | Pressure (bar) | 33 | 48 | 50 | 45 | 52 | 40 | 70 | 58 |
| | Specific energy (in Wh/kg) | 160 | 194 | 185 | 118 | 107 | 190 | 170 | 210 |
| | Knife rotation speed (in rpm) | 1430 | 950 | 1100 | 1000 | 1000 | 980 | 1250 | 950 |
| Textured protein | Dry matter (%) | 96 | 98 | 97 | 97 | 97 | 97 | 96 | 98 |
| analyses | Density (in g/L) | 100 | 120 | 110 | 110 | 120 | 190 | 120 | 100 |
| | Elasticity according to Test A | 3.25 | 4.5 | 3.6 | 4.0 | 4.7 | 4.6 | 3.0 | 3.0 |
| | Fibration (visually assessed) | +++ | +++ | +++ | ++ | + | − | ++ | + |

To clarify the data presented in the previous table:
The parameters of powder flow, water flow and screw speed are applied in a similar way to make the tests comparable.
Parameters such as torque, pressure and specific energy are recorded and are consistent with the parameters mentioned in the previous paragraph. In other words, the variations are a result of the tests and not controlled by them
The cutting speed of the knife is applied and varied to obtain particle sizes of around 1 cm. These variations can be explained by the need to obtain particles of similar size.

The comparison of the various examples shows us:
conventional pea-based textured compositions according to the prior art (Ex. 1) have an elasticity according to Test A of less than 4
Using Nutralys® W (hydrolyzed gluten) to replace 45% F85G (Ex. 4) increases elasticity to over 4, but fibration no longer occurs correctly. The hydrolyzed structure of the gluten protein is most likely no longer sufficient to ensure fibration.
By replacing 30% of the F85G with Nutralys® W (Ex. 2), the fibration is very good while maintaining, surprisingly and unexpectedly, an elasticity greater than 4.
By replacing only 20% of the F85G with Nutralys® W (Ex. 3), the increase in elasticity to a level above 4 is not guaranteed.

We can therefore see that the product according to the invention provides good fibration, but above all an elasticity never before achieved in commercial products.

### Example 2: Impact of the Presence of Plant Fibers

Table 2 below summarizes the various tests carried out as well as the analyses corresponding to the compositions obtained.

| | | Ex. 1 | Ex. 2 | Ex. 6 | Ex. 7 | Ex. 7bis |
|---|---|---|---|---|---|---|
| Composition | Internal pea fibers | 0 | 0 | 12.5 | 12.5 | 12.5 |
| (% total mass of | (PEA FIBER I50M) | | | | | |
| powder fed to | Soluble pea protein isolate | 100 | 70 | 87.5 | 61.3 | 61.3 |
| extruder) | (NUTRALYS F85G) | | | | | |
| | Wheat gluten protein isolate | 0 | 0 | 0 | 0 | 0 |
| | (VITEN) | | | | | |
| | Hydrolyzed wheat gluten protein | 0 | 30 | 0 | 26.3 | 26.2 |
| | isolate (NUTRALYS W) | | | | | |
| Extrusion settings | Powder flow rate (kg/h) | 35 | | | | |
| | Water flow rate (kg/h) | 10.5 | 8 | 9.8 | 4.5 | 3.8 |
| | % water | 23% | 19% | 22% | 11% | 10% |
| | Screw Speed (in rpm) | 1150 | | | | |
| | Torque (%) | 25 | 28 | 27 | 32 | 32 |
| | Pressure (bar) | 33 | 48 | 38 | 47 | 50 |
| | Specific energy (in Wh/kg) | 160 | 194 | 180 | 221 | 250 |
| | Knife rotation speed (in rpm) | 1430 | 950 | 1500 | 680 | 500 |
| Textured protein | Dry matter (%) | | 98 | 93 | 94 | 95 |
| analyses | Density (in g/L) | 100 | 110 | 76 | 100 | 98 |
| | Elasticity according to Test A | 3.25 | 4.5 | 3 | 4.2 | 4.7 |
| | Fibration (visually assessed) | +++ | +++ | + | +++ | + |
| | Water retention (g/g) | | 2.7 | 5.3 | 2.3 | 1.9 |
| | Firmness (kg) | | 6.4 | 8.1 | 9.3 | 9.4 |

To clarify the data presented in the previous table:
The parameters of powder flow, water flow and screw speed are applied in a similar way to make the tests comparable.
Parameters such as torque, pressure and specific energy are recorded and are consistent with the parameters mentioned in the previous paragraph. In other words, the variations are a result of the tests and not controlled by them
The cutting speed of the knife is applied and varied to obtain particle sizes of around 1 cm. These variations can be explained by the need to obtain particles of similar size.

A comparison of the various examples shows that the presence of plant fibers in the extruded composition containing hydrolyzed wheat gluten (see examples 7 and 7bis) preserves its elasticity as shown in example 2, but at the same time achieves a lower water-holding capacity and higher firmness. This is a surprising result, as a firmer, less water-retaining extruded composition should be less elastic, which is not the case here. With this variant of the invention, the person skilled in the art is provided with an elastic, firm composition that retains little water.

### Example 3: Shear Resistance

This part aims to explore the increase in the capacity of the composition according to the invention using a new test called “shear resistance.” The protocol is described below:

### Preparation of the Particles:

200 g+/−1 g of textured protein compositions are hydrated in water to the part with excess T°. Every 5 minutes, mix with a spoon for homogeneous hydration of all TVP. After 30 minutes, remove the water with a strainer (a mesh of approximately 1 mm).
Reserve 60 g of hydrated TVP in water at ambient temperature. Fill a Kenwood FDM30 with hydrated TVP to a volume of approximately 1.5 L. Cut the hydrated TVP in the Kenwood with a kneading blade at speed 1 for 45 s. Homogenize the mixture of particles and reserve 60 g of this first cut in water at ambient temperature.
Cut the rest of the mixture of particles in similar conditions for 105 s. Homogenize the mixture of particles and reserve 60 g of this second cut in water at ambient temperature.
With the sieve, wash the three types of products, complete hydrated TVP, cut 45 s and cut 105+45 s, for one minute each and put 10 g in TP 35.

The purpose of this protocol is therefore to:
Rehydrate textured protein compositions under similar conditions
Impose a similar shear on them for 45 s and 150 s
Observe and compare the number of particles generated during shearing

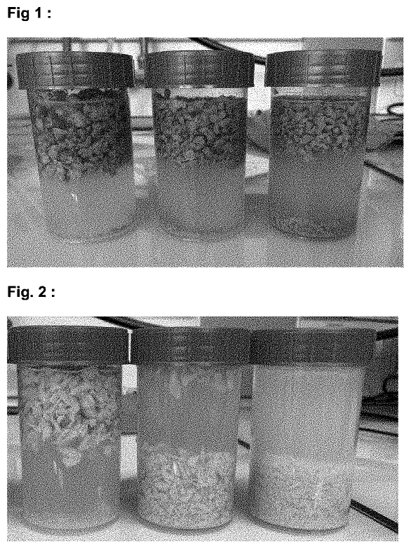

The photos in FIG. 1 show the compositions according to the invention after carrying out the protocol described above.

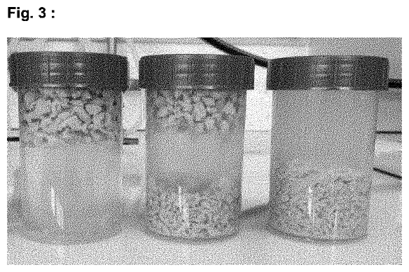

The photos in FIGS. 2 and 3 show the results of previous dry-extruded compositions made from a blend of 70% pea protein and 30% unhydrolyzed wheat gluten (Example 5) and 100% pea protein (Example 1).

It can be clearly seen that the size of the particles making up the extruded composition according to the invention is virtually invariant between T0 (left-hand pot), T45s (middle pot) and T105s (right-hand pot). Conversely, extruded compositions in the prior art (FIG. 2 and FIG. 3) show a reduction in particle size. It is therefore clear that they are less resistant to shearing.

The person skilled in the art can thus clearly see that the behavior of compositions according to the invention is atypical in that, despite the long shear times sometimes required in the food industry, particle size is reduced only slightly.

### Example 4: Evaluating Performance in a Minced Steak Recipe

Table 3 below summarizes the various ingredients required for this recipe:

Hydrated protein composition A

| | | |
|---|---|---|
| Composition according to example 1 | 26.5 | |
| (outside the invention) | | |
| Composition according to example 2 | | 26.5 |
| (according to the invention) | | |

| | |
|---|---|
| Water | 73.5 |
| | Total 100.00 |

Methylcellulose B emulsion

| | |
|---|---|
| First amount of demineralized water 1 | 6 |
| Second amount Demineralized water 2 | 62 |
| Methyl cellulose | 6 |
| Sunflower oil | 26 |
| | Total 100.00 |

Final recipe for minced steak

| | |
|---|---|
| Hydrated protein composition A | 60 |
| Methylcellulose B emulsion | 40 |
| | Total 100.00 |

The recipe for making minced steak with these ingredients is as follows:

### Production of 2000 g of Methylcellulose Emulsion

Disperse methylcellulose in sunflower oil
Add the first quantity of Demineralized Water 1 to a Kenwood bowl, stirring with a blade K, for 30 seconds at maximum speed
Using a spatula, scoop the emulsion from the sides of the bowl and return it to the bottom
Add the second quantity of Demineralized Water 2 to the Kenwood bowl, stirring with a blade K, for 30 seconds at maximum speed
Using a spatula, scoop the emulsion from the sides of the bowl and return it to the bottom
Stir for a final 60 seconds with pale K at maximum speed
Store emulsion for at least 15 minutes in the fridge (about 5° C.)

### Production of 900 g of Hydrated Protein Composition

Place the quantity of extruded protein composition in a container with the quantity of water
Hydrate for 30 min

Production of 1500 g of minced steak
Place 900 g of hydrated protein composition with 600 g of methylcellulose emulsion
Mix with a blade K at speed 1 for 4 min
Shape the dough into 30 g balls, then shape by hand into a minced steak
Cook in the steamer for 6 min at 180° C. at 50% humidity
Vacuum-seal immediately, then freeze
To enjoy, reheat in the oven for 15 min at 180° C., turning the minced steaks halfway through cooking

The firmness of the minced steak is measured after thawing and reheating, using the following protocol:
Firmness is assessed by measuring mechanical resistance (measured in grams) to mechanical penetration by a penetrator, using a TA-XT penetrometer
The probe used for minced steaks after defrosting is P/0.5S (12.66 mm diameter)
the parameters used are: Pre-test speed=1 mm/s/Test speed=1 mm/s/Post-test speed=10 mm/s/Strain=50%
The probe used for minced steaks after cooking is TA-045 (1.5 mm thick and 10 mm wide)
the parameters used are: Pre-test speed=2 mm/s/Test speed=10 mm/s/Post-test speed=10 mm/s/Strain=75%
in both cases (after defrosting and after reheating), 5 measurements were carried out with 5 different minced steaks. The maximum values, expressed in grams, are averaged

Table 4 summarizes the values obtained

| | Minced steak obtained | Minced steak obtained |
|---|---|---|
| | with the extruded | with the extruded |
| | composition of example | composition of example |
| Firmness (in | 1 (outside the | 2 (according to the |
| grams) | invention) | invention) |
| after defrosting | 96.9 | 91.7 |
| after cooking | 650.0 | 1262.1 |

It can be seen that a minced steak made with the extruded composition according to the invention achieves twice as much firmness after cooking as with an extruded composition from the prior art (example 1, 100% peas).

The elasticity of the minced steak is measured after cooking
The elasticity of the TVP in the minced steak is measured as the ratio between the force measured by the TAXT after 30 seconds at 90% compression and 0 seconds at 90% compression
The probe used is a disc called P100 (10 cm in diameter)
The parameters used are: Pre-test speed=2 mm/s, Test speed=1 mm/s, Post-test speed=10 mm/s, Strain=90% and a compression time of 30 seconds
5 measurements are taken to obtain an average

Table 5 summarizes the values obtained

| | Minced steak obtained | Minced steak obtained |
|---|---|---|
| | with the extruded | with the extruded |
| | composition of example | composition of example |
| Elasticity | 1 (outside the | 2 (according to the |
| (in %) | invention) | invention) |
| after cooking | 27.1 | 42.8 |

It can be seen that the minced steak made with the extruded composition according to the invention is about 1.5 times more elastic after cooking than with an extruded composition from the prior art (example 1, 100% peas).

1. A dry-extruded composition comprising plant proteins excluding hydrolyzed wheat gluten, preferentially leguminous proteins, preferentially pea proteins, as well as hydrolyzed wheat gluten.

2. The composition according to claim 1, wherein an elasticity measured by Test A of between 3.5 and 5, preferentially between 4 and 5, preferentially between 4.2 and 4.8, preferentially between 4.4 and 4.6.

3. The composition according to claim 1, wherein a firmness measured by Test B of between 5 and 10, preferentially between 5.5 and 9.5.

4. The composition according to claim 1, wherein a water retention capacity measured by Test C of between 1.5 and 3.5, preferentially between 1.7 and 3.2.

5. The composition according to claim 1, wherein the percentage of hydrolyzed wheat gluten contained in the total proteins is between 22% and 40% on a dry matter basis, preferentially between 22% and 38%, preferentially between 24% and 36%, preferentially between 26% and 34%, more preferentially between 28% and 32%.

6. The composition according to claim 1, wherein the percentage of plant proteins excluding hydrolyzed wheat gluten, preferentially leguminous proteins, preferentially pea proteins, contained in the total proteins is between 88% and 60% on a dry matter basis, preferentially between 88% and 62%, preferentially between 76% and 64%, preferentially between 74% and 66%, preferentially between 72% and 68%.

7. The composition according to claim 1, wherein the hydrolyzed wheat gluten is characterized by a degree of hydrolysis (DH) of 0.5% to 5%, preferably 1% to 4%, preferably 2% to 3%.

8. The composition according to claim 1, wherein the total protein content within the composition ranges between 60% and 80% by dry weight with respect to the total weight of dry matter of the composition, preferentially between 70% and 80% by dry weight relative to the total weight of dry matter of the composition.

9. The composition according to claim 1, wherein it has a dry matter content greater than 80% by dry weight relative to the total weight of dry matter of the composition, preferentially greater than 90% by weight, preferentially between 90% and 100%, preferentially between 95% and 98%.

10. The composition according to claim 1, wherein it comprises plant fibers, preferentially plant fibers, preferentially leguminous fibers, preferentially pea fibers, in a total protein/plant fiber weight ratio of between 70/30 and 90/10, preferentially between 85/15 and 90/10.

11. A method for producing a composition according to claim 1, wherein the method comprises the following steps:
1) Providing a dry powder mixture comprising a material rich in plant proteins excluding hydrolyzed wheat gluten, preferentially from legumes, preferentially peas, and a material rich in hydrolyzed wheat gluten in relative quantities enabling a mixture to be obtained in which the percentage of hydrolyzed wheat gluten contained in the total proteins is between 22% and 40% on a dry matter basis, preferentially between 22% and 38%, preferentially between 24% and 36%, preferentially between 26% and 34%, preferentially between 28% and 32%.
2) Dry-extrusion cooking the mixture provided in step 1 with the addition of water to achieve a water content in the extruder of between 1% and 30%,
3) Cutting the extruded composition at extruder outlet, preferentially consisting of an outlet die with orifices, and
4) Optionally drying the composition thus obtained.

12. The method according to claim 11, wherein the hydrolyzed wheat gluten used in step 1 has a degree of hydrolysis (DH) of 0.5% to 5%, preferably 1% to 4%, preferably 2% to 3%.

13. The method according to claim 11, wherein the plant proteins excluding hydrolyzed wheat gluten, preferentially leguminous proteins, preferentially pea proteins, as well as hydrolyzed wheat gluten are isolates with a protein content on a dry matter basis of between 60% and 90%, preferentially between 70% and 85%, even more preferentially between 75% and 85% by weight relative to the total dry matter of the composition.

14. The method according to claim 11, wherein the dry powder mixture of step 1 also comprises plant fibers, preferentially leguminous plants, with a dry weight ratio of total proteins/plant fibers, preferentially leguminous plants, ranging from 70/30 to 90/10, preferentially from 85/15 to 90/10.

15. The use of a dry-extruded composition comprising plant proteins excluding hydrolyzed wheat gluten, preferentially leguminous proteins, preferentially pea proteins, as well as hydrolyzed wheat gluten, or manufactured according to the method of claim 11, in a composition chosen from a food composition, a pharmaceutical composition or a cosmetic composition.

16. The use of a dry-extruded composition comprising plant proteins excluding hydrolyzed wheat gluten, preferentially leguminous proteins, preferentially pea proteins, as well as hydrolyzed wheat gluten, or manufactured according to the method of claim 11, in a food composition which is a meat analogue, such as minced meat, steaks, chicken fillets, chicken nuggets, sausages.

17. The use of a dry-extruded composition comprising plant proteins excluding hydrolyzed wheat gluten, preferentially leguminous proteins, preferentially pea proteins, as well as hydrolyzed wheat gluten, or manufactured according to the method of claim 11, in a food composition intended for preparing a bakery or pastry product.
